(19) United States
(12) Patent Application Publication
(10) Pub. No.: US 2006/0016848 A1
(43) Pub. Date: Jan. 26, 2006

(54) Apparatus for evenly stapling stacks of paper at a desired angle

(76) Inventor: Iraj Basti, Santa Ana, CA (US)

Correspondence Address: Joseph S. Farzam, Esq., Suite 1770, 1875 Century Park East, Los Angeles, CA, 90067, US

(21) Appl. No.: 10/898,906

(22) Filed: Jul. 26, 2004

(51) Int. Cl. B25C 5/02

(52) U.S. Cl. 227/154; 227/134

(57) ABSTRACT

A stapler for evenly stapling stacks of paper at a desired angle is presented. An arm having a cartridge for dispensing staples is movably connected to a base and a paper director is coupled with the base between the anvil and the back having a V-shaped raised opening the V having a 90° angle (right angle), facing away from the back of the base such that stapling a stack of paper evenly is achieved through placing the top left corner of a stack of paper on the base of the stapler aligned with the V-shaped raised opening and pressing the arm of the stapler down against the stack of paper. The paper director can be movably connected with the base such that the paper director can slide back and forth on the base as to enable one to staple a stack of paper evenly in various desired places on the paper. Also the base can further include indentations parallel to the anvil and at various distances from the anvil and the paper director includes a stopper in the area that the paper director is connected to the base such that as the paper director is moved alongside the base the paper director can be secured at various distances from the anvil by allowing the stopper to lock into the indentations thereby preventing the paper director from freely sliding back and forth when a stack of paper is pressed against it.

### BACKGROUND

(1) Technical Field

The present invention relates to the field of staplers, and more particularly to an apparatus for aligning and positioning stacks of paper on a stapler.

(2) Discussion

Most staples that are used in offices today have no means of aligning and positioning stacks of paper so as to enable one to staple the papers evenly. Stacks of paper are usually stapled at the top left corner. The conventional stapler provides no guidance for where on the paper the staples can be placed. Therefore, staples are usually placed unevenly at different areas of the top left corner of a stack of paper. This not only leads to an uneven and unorganized appearance but also makes flipping through pages difficult as the pages that are flipped do not sit evenly to the top left of the stack so as to provide easy reading of the following pages. Therefore, staples usually have to be removed and the stack re-stapled or the reader has to struggle by pulling the flipped over paper upwards to read the next page.

A number of prior art paper guide mechanisms have addressed this problem. However, none has been as simple and as cost efficient to manufacture as the mechanisms of the present invention. The prior art paper guides are also more difficult to adjust.

Thus there is a need in the art for a stapler that has a simple and cost efficient mechanism for guiding a stack of paper for even stapling.

### SUMMARY

A stapler for evenly stapling stacks of paper at a desired angle is presented. An arm having a cartridge for dispensing staples is movably connected to a base and a paper director is coupled with the base between the anvil and the back having a V-shaped raised opening the V having a 90° angle (right angle), facing away from the back of the base such that stapling a stack of paper evenly is achieved through placing the top left corner of a stack of paper on the base of the stapler aligned with the V-shaped raised opening and pressing the arm of the stapler down against the stack of paper.

The paper director can be movably connected with the base such that the paper director can slide back and forth on the base as to enable one to staple a stack of paper evenly in various desired places on the paper. Also the base can further include indentations parallel to the anvil and at various distances from the anvil and the paper director includes a stopper in the area that the paper director is connected to the base such that as the paper director is moved alongside the base the paper director can be secured at various distances from the anvil by allowing the stopper to lock into the indentations thereby preventing the paper director from freely sliding back and forth when a stack of paper is pressed against it.

In another embodiment of the present invention, the stapler includes a hollow box shaped paper director having an upper surface, an open back, a closed front, a V-shaped raised opening the V having a 90° angle (right angle) on the upper surface, an aperture on the upper surface between the V-shaped raised opening and the closed front such that stapling a stack of paper evenly is achieved through placing the hollow box shaped paper director on the front end of the base exposing the anvil through the aperture and placing the top left corner of a stack of paper on the base of the stapler aligned with the V-shaped raised opening and pressing the arm of the stapler down against the stack of paper.

In yet another embodiment, the stapler includes a paper director having a flat surface with two raised adjacent sides at a right angle and a corner between the raised adjacent sides and a hollow box shaped opening in the corner such that stapling a stack of paper is achieved through placing the hollow box shaped opening of the paper director on the front end of the base and placing a stack of paper on the flat surface of the paper director with the top left corner of the stack of paper aligned with the raised adjacent sides of the paper director and pressing the arm of the stapler down against the stack of paper.

### BRIEF DESCRIPTION OF THE DRAWINGS

These and other features, aspects, and advantages of the present invention will become better understood with regard to the following description, appended claims, and accompanying drawings where:

FIG. 1 is a pictorial representation of a stapler comprising a V-shaped opening according to the present invention;

FIG. 2 is a pictorial representation of a stapler comprising a paper director that can slide back and forth on the base according to the present invention;

FIG. 3 is a pictorial representation of a stapler comprising a paper director with a stopper that can be secured on the base at various intervals according to the present invention.

FIG. 4 and FIG. 5 is a pictorial representation of a stapler comprising a hollow box shaped paper director having a V-shaped raised opening on the upper surface according to the present invention.

FIG. 5 and FIG. 7 is a pictorial representation of a stapler comprising a paper director having a flat surface with two raised adjacent sides at a right angle and a corner between the raised adjacent sides and a hollow box shaped opening in the corner according to the present invention.

### DETAILED DESCRIPTION

The present invention relates to the field of staplers, and more particularly to an apparatus for aligning and positioning stacks of paper on a stapler. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

(1) Introduction

The present invention provides a stapler for evenly stapling stacks of paper at a desired angle is presented. An arm having a cartridge for dispensing staples is movably connected to a base and a paper director is coupled with the base between the anvil and the back having a V-shaped raised opening the V having a 90° angle (right angle), facing away from the back of the base such that stapling a stack of paper evenly is achieved through placing the top left corner of a stack of paper on the base of the stapler aligned with the V-shaped raised opening and pressing the arm of the stapler down against the stack of paper.

The paper director can be movably connected with the base such that the paper director can slide back and forth on the base as to enable one to staple a stack of paper evenly in various desired places on the paper. Also the base can further include indentations parallel to the anvil and at various distances from the anvil and the paper director includes a stopper in the area that the paper director is connected to the base such that as the paper director is moved alongside the base the paper director can be secured at various distances from the anvil by allowing the stopper to lock into the indentations thereby preventing the paper director from freely sliding back and forth when a stack of paper is pressed against it.

(2) Discussion

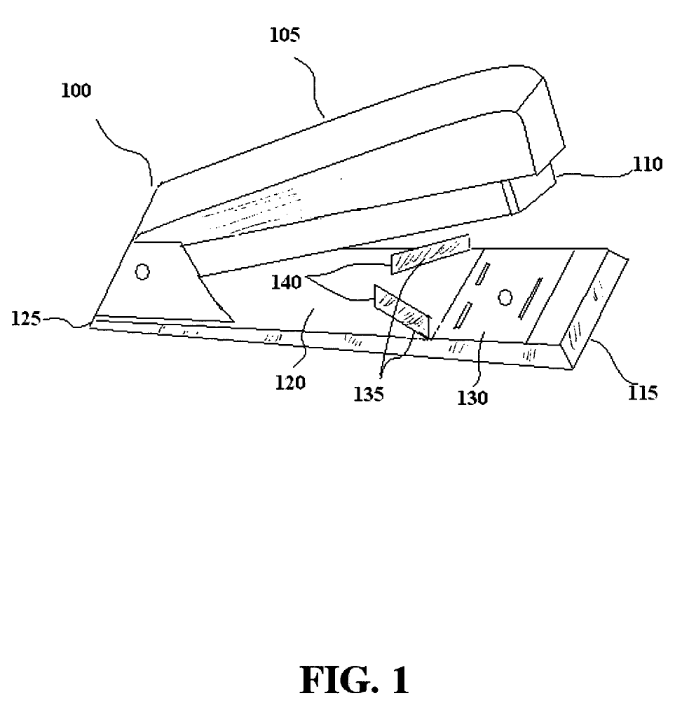

FIG. 1 is a pictorial representation of a stapler comprising a V-shaped opening according to the present invention. This stapler 100 comprises an arm 105 having a cartridge 110 for dispensing staples. A base 115 is movably connected with the arm 105 having a top 120, a back 125 and an anvil 130 such that the arm 105 is movably secured to the back 125 of the base 115. A paper director 135 connected with the base 115 between the anvil 130 and the back 125 having a V-shaped raised opening 140 the V having a 90° angle (right angle), facing away from the back 125 of the base 115 such that stapling a stack of paper evenly is achieved through placing the top left corner of a stack of paper on the base 115 of the stapler 100 aligned with the V-shaped raised opening 140 and pressing the arm 105 of the stapler 100 down against the stack of paper.

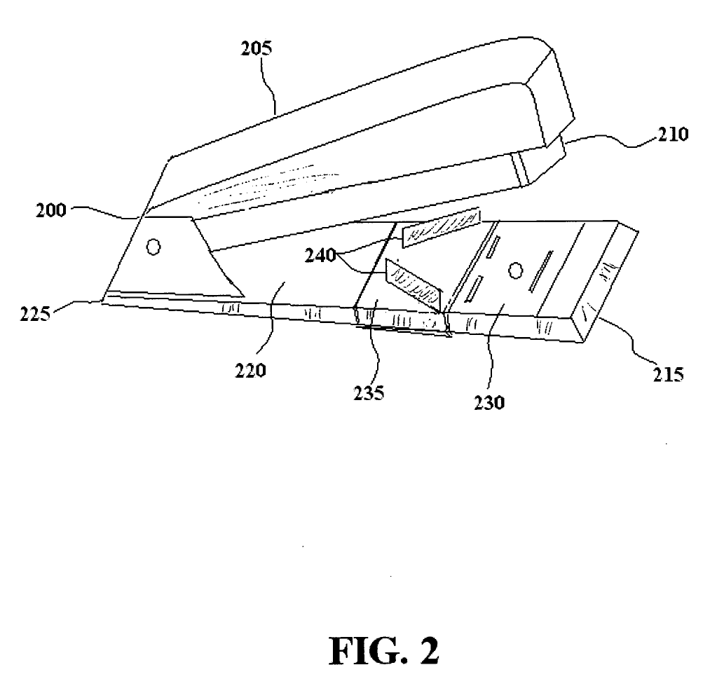

FIG. 2 is a pictorial representation of another embodiment of the present invention wherein a stapler comprising a paper director that can slide back and forth on the base. This stapler 200 comprises an arm 205 having a cartridge 210 for dispensing staples. A base 215 is movably connected with the arm 205 having a top 220, a back 225 and an anvil 230 such that the arm 205 is movably secured to the back 225 of the base 215. A paper director 235 connected with the base 215 between the anvil 230 and the back 225 having a V-shaped raised opening 240 the V having a 90° angle (right angle), facing away from the back 225 of the base 215. The paper director 235 is movably connected with the base 215 such that the paper director 235 can slide back and forth on the base 215 as to enable one to staple a stack of paper evenly in various desired places on the paper.

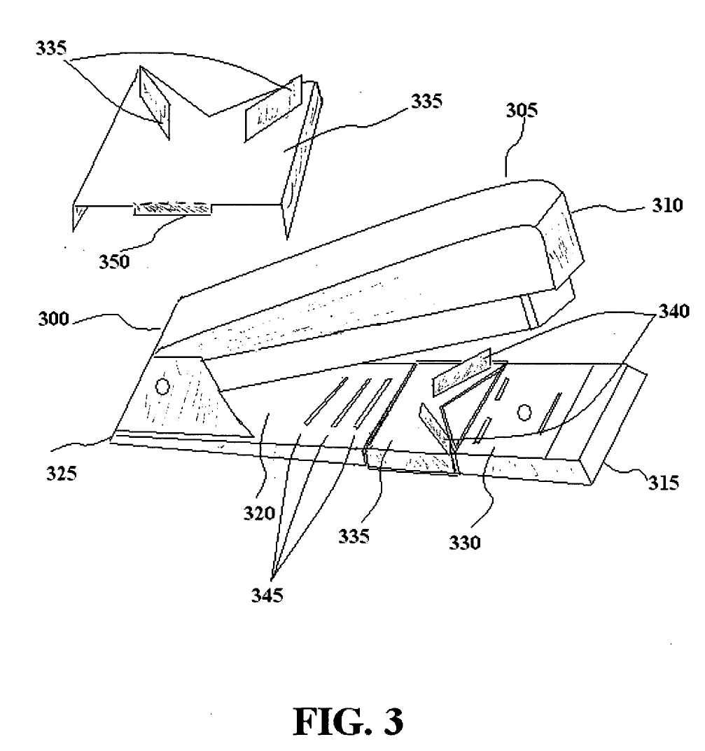

FIG. 3 is a pictorial representation of yet another embodiment of the present invention wherein a stapler comprising a paper director with a stopper that can be secured on the base at various intervals. The stapler 300 of this embodiment comprises an arm 305 having a cartridge 310 for dispensing staples. A base 315 is movably connected with the arm 305 having a top 320, a back 325 and an anvil 330 such that the arm 305 is movably secured to the back 325 of the base 315. A paper director 335 connected with the base 315 between the anvil 330 and the back 325 having a V-shaped raised opening 340 the V having a 90° angle (right angle), facing away from the back 325 of the base 315. The paper director 335 is movably connected with the base 315 such that the paper director 335 can slide back and forth on the base 315 as to enable one to staple a stack of paper evenly in various desired places on the paper. The top of the base 315 further includes indentations 345 parallel to the anvil 330 and at various distances from the anvil 330 and the paper director 335 further includes a stopper 350 in the area that the paper director 335 is connected to the base 315 such that as the paper director 335 is moved alongside the base 315, the paper director 335 can be secured at various distances from the anvil 330 by allowing the stopper 350 to lock into the indentations 345 thereby preventing the paper director 335 from freely sliding back and forth when a stack of paper is pressed against it.

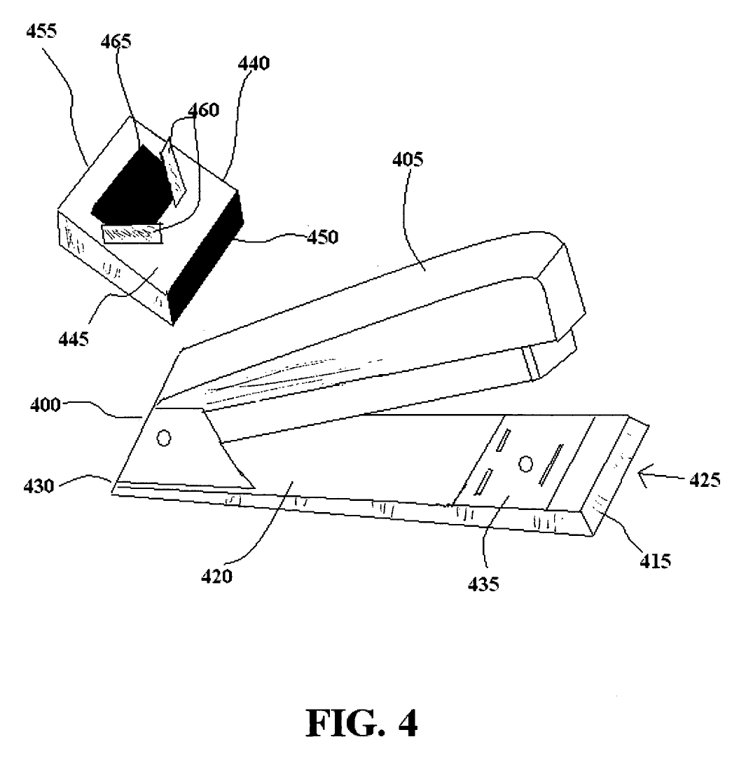

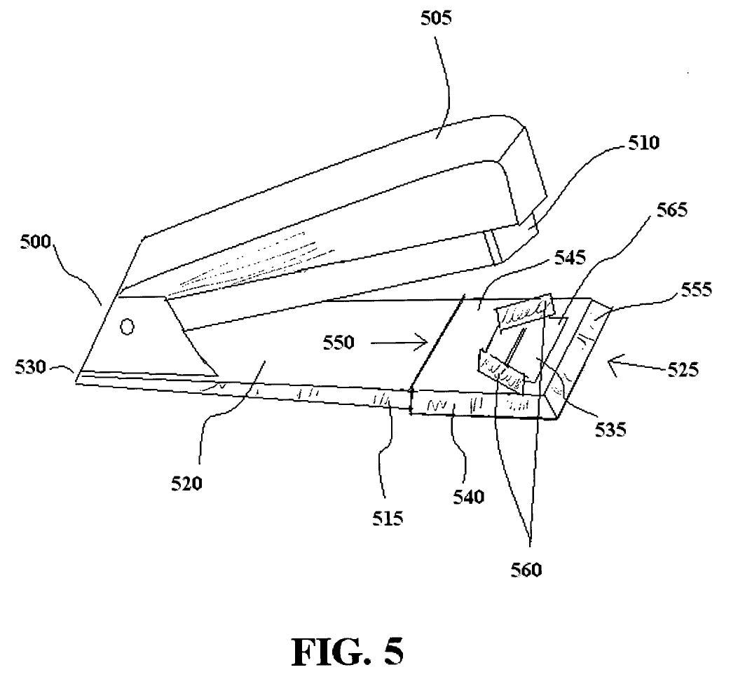

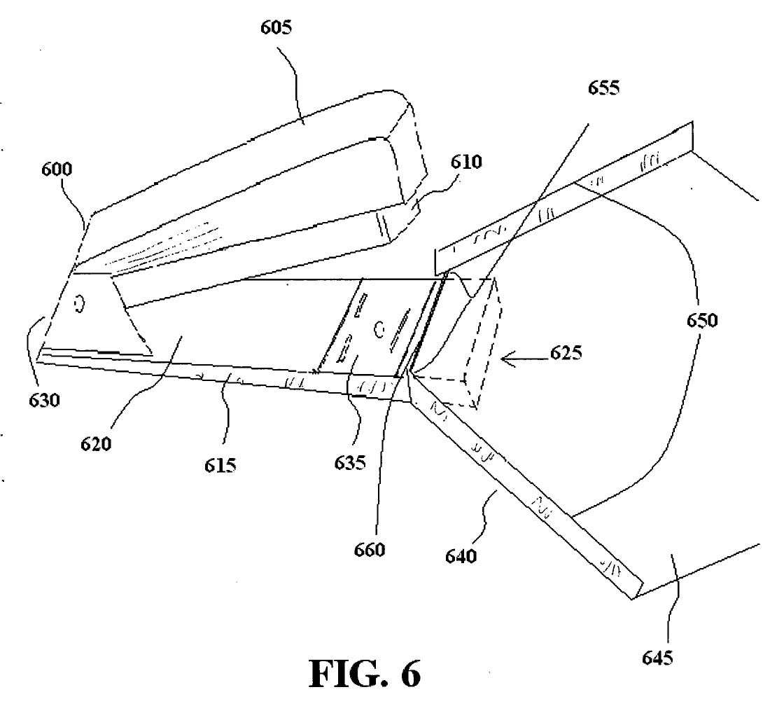

FIG. 4 and FIG. 5 is a pictorial representation of a stapler comprising a hollow box shaped paper director having a V-shaped raised opening on the upper surface according to the present invention. The stapler 400,500 of this embodiment comprises an arm 405,505 having a cartridge 410,510 for dispensing staples. A base 415,515 movably connected with the arm 405,505 having a top 420,520, a front end 425,525, a back 430,530 and an anvil 435,535 such that the arm 405,505 is movably secured to the back 430,530 of the base 415,515 and a hollow box shaped paper director 440,540 having an upper surface 445,545, an open back 450,550, a closed front 455,555, a V-shaped raised opening 460,560 the V having a 90° angle (right angle) on the upper surface 445,545, an aperture 465,565 on the upper surface 445,545 between the V-shaped raised opening 460,560 and the closed front 455,555 such that stapling a stack of paper evenly is achieved through placing the hollow box shaped paper director 440,540 on the front end 425,525 of the base 415,515 exposing the anvil 435,535 through the aperture 465, 565 and placing the top left corner of a stack of paper on the base 415,515 of the stapler 400,500 aligned with the V-shaped raised opening 460,560 and pressing the arm 405,505 of the stapler 400,500 down against the stack of paper.

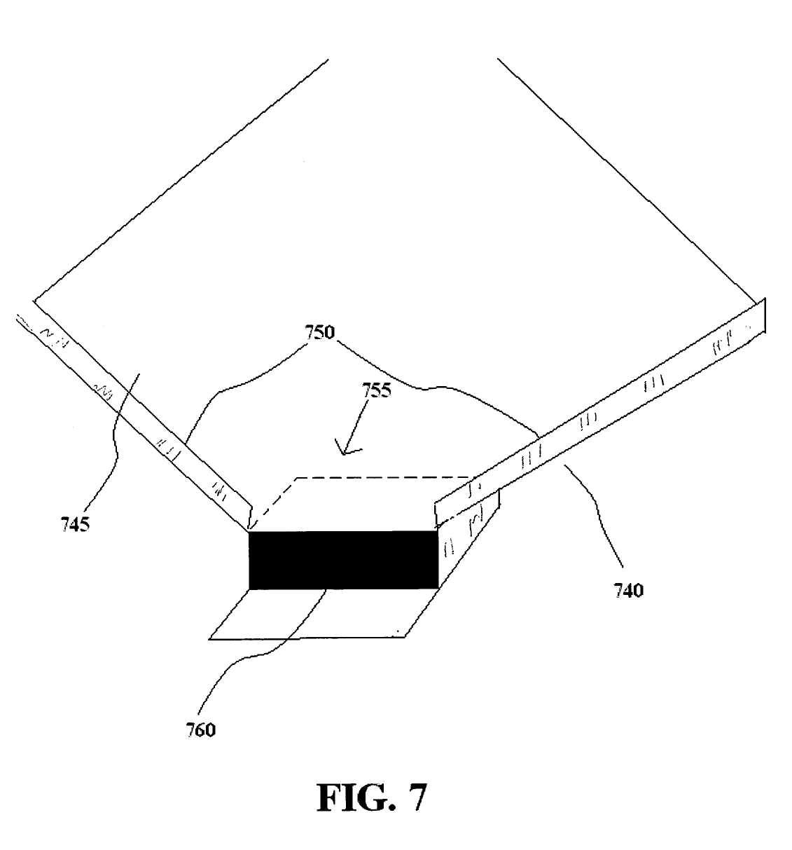

FIG. 6 and FIG. 7 is a pictorial representation of a stapler comprising a paper director having a flat surface with two raised adjacent sides at a right angle and a corner between the raised adjacent sides and a hollow box shaped opening in the corner according to the present invention. This stapler 600 comprises an arm 605 having a cartridge 610 for dispensing staples and a base 615 movably connected with the arm 605 having a top 620, a front end 625, a back 630 and an anvil 635 such that the arm 605 is movably secured to the back 630 of the base 615 and a paper director 640,740 having a flat surface 645, 745 with two raised adjacent sides 650, 750 at a right angle and a corner 655,755 between the raised adjacent sides 650,750 and a hollow box shaped opening 660,760 in the corner 655,755 such that stapling a stack of paper is achieved through placing the hollow box shaped opening 660,760 of the paper director 640,740 on the front end of the base 615 and placing a stack of paper on the flat surface 645,745 of the paper director 640,740 with the top left corner of the stack of paper aligned with the raised adjacent sides 650,750 of the paper director 640,740 and pressing the arm 605 of the stapler 600 down against the stack of paper.

What is claimed is:

1. A stapler for evenly stapling stacks of paper at a desired angle, the stapler comprising:
a. an arm having a cartridge for dispensing staples;
b. a base movably connected with the arm having a top, a back, and an anvil such that the arm is movably secured to the back of the base; and
c. a paper director connected with the base between the anvil and the back having a V-shaped raised opening the V having a 90° angle (right angle), facing away from the back of the base such that stapling a stack of paper evenly is achieved through placing the top left corner of a stack of paper on the base of the stapler aligned with the V-shaped raised opening and pressing the arm of the stapler down against the stack of paper.

2. A stapler for evenly stapling stacks of paper at a desired angle as set forth in claim 1, wherein the paper director is movably connected with the base such that the paper director can slide back and forth on the base as to enable one to staple a stack of paper evenly in various desired places on the paper.

3. A stapler for evenly stapling stacks of paper at a desired angle as set forth in claim 2, wherein the top of the base further includes indentations parallel to the anvil and at various distances from the anvil and the paper director further includes a stopper in the area that the paper director is connected to the base such that as the paper director is moved alongside the base, the paper director can be secured at various distances from the anvil by allowing the stopper to lock into the indentations thereby preventing the paper director from freely sliding back and forth when a stack of paper is pressed against it.

4. A stapler for evenly stapling stacks of paper at a desired angle, the stapler comprising:
a. an arm having a cartridge for dispensing staples;
b. a base movably connected with the arm having a top, a front end, a back and an anvil such that the arm is movably secured to the back of the base; and
c. a hollow box shaped paper director having an upper surface, an open back, a closed front, a V-shaped raised opening the V having a 90° angle (right angle) on the upper surface, an aperture on the upper surface between the V-shaped raised opening and the closed front such that stapling a stack of paper evenly is achieved through placing the hollow box shaped paper director on the front end of the base exposing the anvil through the aperture and placing the top left corner of a stack of paper on the base of the stapler aligned with the V-shaped raised opening and pressing the arm of the stapler down against the stack of paper.

5. A stapler for evenly stapling stacks of paper at a desired angle, the stapler comprising:
a. an arm having a cartridge for dispensing staples;
b. a base movably connected with the arm having a top, a front end, a back and an anvil such that the arm is movably secured to the back of the base; and
c. a paper director having a flat surface with two raised adjacent sides at a right angle and a corner between the raised adjacent sides and a hollow box shaped opening in the corner such that stapling a stack of paper is achieved through placing the hollow box shaped opening of the paper director on the front end of the base and placing a stack of paper on the flat surface of the paper director with the top left corner of the stack of paper aligned with the raised adjacent sides of the paper director and pressing the arm of the stapler down against the stack of paper.
